(19) United States
(12) Patent Application Publication
(10) Pub. No.: US 2005/0121387 A1
(43) Pub. Date: Jun. 9, 2005

(54) Bacteriostatic fluid filter

(76) Inventors: Roy W. Kuennen, Caledonia, MI (US); Karen J. VanderKooi, Grand Rapids, MI (US); Roy M. Taylor JR., Rockford, MI (US); Anne Hoyt, Lowell, MI (US)

Correspondence Address: ALTICOR INC., 7575 FULTON STREET EAST MAILCODE 78-2G, ADA, MI, 49355, US

(21) Appl. No.: 11/003,290

(22) Filed: Dec. 3, 2004

Related U.S. Application Data
(60) Provisional application No. 60/526,735, filed on Dec. 4, 2003.
(60) Provisional application No. 60/612,804, filed on Sep. 24, 2004.

(51) Int. Cl. B01D 39/02

(52) U.S. Cl. 210/503; 210/506; 210/266

(57) ABSTRACT

A bacteriostatic water filter comprised of a contiguous block of activated carbon, copper, and binder, and the method of making the same. According to one embodiment, the block is comprised of between 60% and 80% by weight of activated carbon with a mesh size of about 40×140. The block is further comprised of 2% to 15% copper particles by weight, based on the combined weight of the activated carbon, the copper particles, and the binder, and 15% to 25% by weight of carbon block binder, based on the combined weight of the activated carbon, the copper particles, and the binder. According to another embodiment, the activated carbon is comprised of silver treated activated carbon.

This application claims the benefit under 35 U.S.C. §119(e) of U.S. provisional patent application Ser. No. 60/526,735 entitled Bacteriostatic Water Filter, which was filed on Dec. 4, 2003, and U.S. provisional patent application Ser. No. 60/612,804 entitled Bacteriostatic Water Filter, which was filed on Sep. 24, 2004.

### SUMMARY OF THE INVENTION

One embodiment of the present invention provides a fluid filter comprised of activated carbon particles, a binder and copper particles. A second embodiment of the present invention provides a fluid filter comprising a silver treated activated carbon block, a binder, and copper particles. The presence of copper in the filter, and the combination of copper and silver treated activated carbon, may inhibit the growth of bacteria on or within the filter over time.

### BRIEF DESCRIPTION OF THE DRAWINGS

FIG. 1 is a cross sectional perspective view of a bacteriostatic water filter manufactured in accordance with the illustrated embodiment of the present invention.

### DETAILED DESCRIPTION OF THE ILLUSTRATED EMBODIMENT

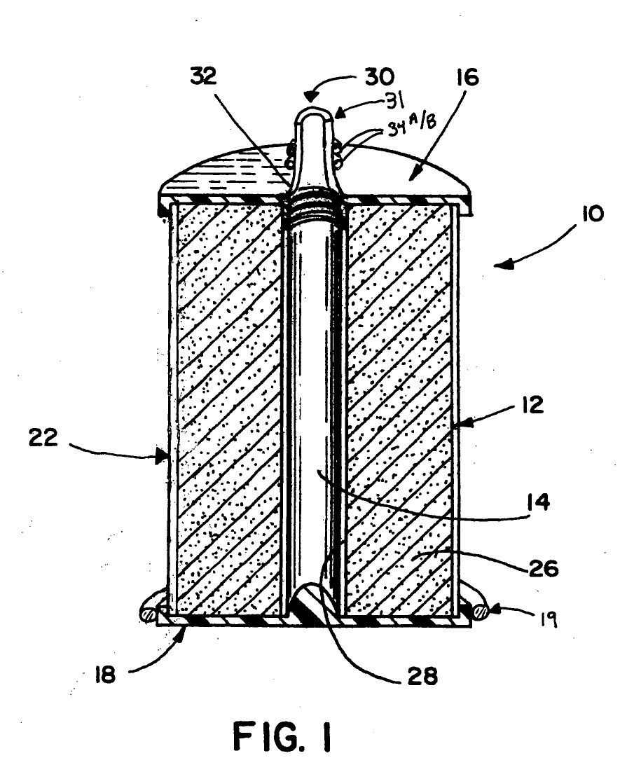

Referring to FIG. 1, bacteriostatic water filter 10 is comprised of filter block 12, top end cap 16, bottom end cap 18, optional plastic core 14, and optional nonwoven fabric scrim 22. Filter block 12 is further comprised of central opening 28 and circumferential wall 26.

Top end cap 16 is disposed on the top axial end of filter block 12. According to the illustrated embodiment, top end cap 16 is manufactured from a nonporous polymeric material, such as polypropylene. Top end cap 16 preferably defines a central opening 32 that is coaxial with central opening 28 of filter block 12. Neck 31 defines an aperture 30 that is in fluid communication with central opening 32 of top end cap 16, and central opening 28 of filter block 12. Neck 31 is adapted to be press fit into the deck of a water treatment system (not shown), and is further comprised of a plurality of top elastomeric o-rings 34 A/B. Neck 31 may be threaded or otherwise adapted to permit the bacteriostatic water filter 10 to be removably mounted to the deck of a water treatment system (not shown). One water treatment system that may incorporate the present invention is described in U.S. Pat. No. 6,245,229 entitled “Point-Of-Use Water Treatment System”, issued Jun. 12, 2001, to Kool et al., the subject matter of which is hereby incorporated by reference.

Bottom end cap 18 is disposed on the bottom axial end of filter block 12. Bottom end cap 18 of the illustrated embodiment is fully closed and does not include openings. Bottom end cap 18 of the illustrated embodiment is further comprised of bottom elastomeric o-ring 19.

Optional plastic core 14 is a conventional nonwoven plastic material, such as spun-bonded polypropylene, that defines a porous circumferential wall that permits water to flow readily through the core, particularly in a radial direction. According to the illustrated embodiment, plastic core 14 is manufactured from a rolled sheet of the desired nonwoven material. The outer diameter of the plastic core 14 will vary from application to application. According to the illustrated embodiment, plastic core 14, if installed, fits snugly within central opening 28 of filter block 12.

According to one embodiment, filter block 12 is comprised of a hollow core cylindrical block of bonded, activated carbon, a binder, and copper particles as described in more detail below. Although described in connection with a hollow core cylindrical block, the present invention is well suited for use in other fluid filters, such as granular filters or filter beds. As used herein, the terms “inner,” “inwardly,” “outer,” and “outwardly” are used to refer to directions relative to the geometric axial center of the filter block 12. For purposes of this disclosure, the carbon particle size and size distribution will generally be described in terms of mesh sizes as measured using a generally conventional wet sieve analysis. A wet sieve analysis is a conventional process in which a carbon mixture is separated into ranges or “bins” based on particle size. In general, the carbon mixture is passed, with the aid of water, sequentially through a series of screens, each with progressively smaller openings, down to a 500 mesh screen. Particles larger than the opening size of a specific screen will remain atop that screen while smaller particles will pass through the screen to the next smaller screen. Particles smaller than the openings of 500 mesh screen are typically referred to as “fines.” The level of fines can vary significantly from carbon mixture to carbon mixture, and in some carbon mixtures may comprise as much as 20% by weight. Fines are typically disregarded by the carbon producers themselves in grading their carbons. As an expedient, conventional mesh size notation will be used to refer to size ranges. More specifically, the notation “+” in front of a mesh size refers to particles too large to pass through a screen of the noted size. For example, +140 mesh refers to particles that are too large to pass through a screen of 140 mesh size. Similarly, the notation “−” in front of a mesh size refers to particles small enough to pass through a screen of the noted size. In referring to particle distributions, the notation “x” between two mesh sizes refers to a range of sizes. For example, 140×200 refers to a range or bin of carbon particle sizes smaller than 140 mesh and greater than 200 mesh.

According to one embodiment of the present invention, filter block 12 is further comprised of 15% to 25% by weight of the binder, based on the combined weight of the activated carbon, the copper particles, and the binder. According to another embodiment, filter block 12 of the illustrated embodiment is further comprised of 19% to 21% by weight of the binder based on the combined weight of the activated carbon, the copper, and the binder. According to one embodiment, the binder is a polymeric material with a very low melt index (melt flow rate) and is an ultra high molecular weight, high density polyethylene, such as Hostalen® GUR-212. Alternative binders that can be used with the carbon filter of the present invention are disclosed and described in connection with the carbon block filter of U.S. Pat. No. 4,753,728 entitled “Water Filter”, issued Jun. 28, 1988, to VanderBilt et al, the subject matter of which is incorporated herein by reference.

According to one embodiment, filter block 12 is a contiguous block of activated carbon and copper particles bonded together by a binder as described in more detail below. According to a second embodiment, filter block 12 is comprised of 60% to 80% by weight of activated carbon, based on the combined weight of the activated carbon, the copper particles, and the binder. According to another embodiment of the present invention, filter block 12 is comprised of 68% to 72% by weight of activated carbon, based on the combined weight of the activated carbon, the copper particles, and the binder. The activated carbon according to the illustrated embodiment is comprised of activated coconut carbon with a mesh size of about 40×140, with a maximum of 3% by weight +30 mesh size, and a maximum of 4% by weight −140 mesh size.

According to another embodiment of the present invention, filter block 12 is comprised of 2% to 15% or more of copper particles by weight, based on the combined weight of the activated carbon, the copper particles, and the binder. According to another embodiment, filter block 12 of the illustrated embodiment is comprised of 9% to 11% or more of copper particles by weight, based on the combined weight of the activated carbon, the copper particles, and the binder.

The copper particles of the illustrated embodiment are comprised of a minimum 90% copper by weight, based on the combined weight of the copper and the alloy metal and the impurities in the alloy. The copper particles are granular, with a mesh size of 60 to 200. One example of copper particles used in the illustrated embodiment is KDF CF100 manufactured by KDF Fluid Treatment, Incorporated, of Three Rivers, Mich.

According to another embodiment of the present invention, carbon block 12 is comprised of a hollow core cylindrical block of bonded, silver treated activated carbon, a binder, and copper particles. According to this embodiment, carbon block 12 is comprised of 60% to 80% by weight, of silver treated activated carbon, based on the combined weight of the silver treated activated carbon, the copper particles, and the binder. According to another embodiment, carbon block 12 is comprised of 68% to 72% by weight, of silver treated activated carbon, based on the combined weight of the silver treated activated carbon, the copper particles, and the binder. The silver treated activated carbon of the illustrated embodiment is comprised of activated coconut carbon with a mesh size of about 40×140, with a maximum of 3% by weight +30 mesh size, and a maximum of 4% by weight −140 mesh size. According to one embodiment, the activated carbon is treated with between 0.1% to 0.5% silver by weight, based on the combined weight of the silver and the carbon. According to another embodiment, the activated carbon is treated with between 0.2% to 0.3% silver by weight, based on the combined weight of the silver and the carbon. Silver treated activated carbon is available “off the shelf” from carbon manufacturers, and is used by a variety of carbon block manufacturers without modification. One example of a silver treated carbon is SG6-AG available from Cameron Carbon Incorporated of Baltimore, Md.

The presence of copper particles in the carbon filter, and the combination of silver treated carbon and copper particles, may inhibit the growth of bacteria on or within the filter. Natural occurring heterotrophic plate count (“HPC”) bacteria occur in chlorinated drinking water, and are known to colonize activated carbon filters. These harmless bacteria are normal in chlorinated drinking water, but when the activated carbon removes the chlorine, the bacteria may establish colonies on the carbon, resulting in significantly higher bacteria counts. It is common for carbon filters to have 2-5 orders of magnitude increases in HPC bacteria counts in the effluent after the filters are colonized by the bacteria. The National Sanitary Foundation International (“NSF”) has established a test method for testing drinking water filters for their bacteriostatic effects to suppress the growth of the HPC bacteria, known as the NSF/ANSI Standard 42, Standard 42-2002 Drinking Water Treatment Units—Aesthetic Effects for Bacteriostasis test. The filters of the illustrated embodiments were tested according to a modified version of the NSF/ANSI Standard 42, Standard 42-2002 Drinking Water Treatment Units—Aesthetic Effects for Bacteriostasis test. According to the modified version of this test, water passes through the filters in a number of on/off cycles that simulates normal use, and includes stagnation periods. Five days per week, water is pumped through the filters in a 1 minute on/59 minutes off cycle for 16 hours per day. There is also a 48 hour stagnation time each week. The test is conducted for not less than 6 weeks and not more than 13 weeks.

The number of HPC bacteria in the influent and effluent waters is monitored through the length of the test. The test was modified by raising the water temperature in the test from 20 degrees C. to 40 degrees C. The water was also stored in a tank after it was dechlorinated. These modifications allowed the HPC bacteria to multiply in the water to counts higher than specified in the test standard. Duplicate filters of each embodiment were tested for a 12 week period.

A total of 6 filters were tested according to the protocol discussed above. Two of the filters tested were comprised of activated carbon and a binder, and contained no copper and no silver treated activated carbon. Two of the filters tested were comprised of activated carbon, a binder, and 10% copper particles by weight, based on the combined weight of the activated carbon, the copper particles, and the binder. Finally, two of the filters tested were comprised of a binder, activated carbon treated with 0.1% silver by weight, based on the combined weight of the silver and the carbon, and 10% copper particles by weight, based on the combined weight of the silver treated activated carbon, the copper particles, and the binder. Results of these tests were averaged and are provided in the table below. The first column indicates the percentage of silver and copper in the filters as discussed above. The second column provides the HPC count of the filter influent per milliliter (“ml”) of water as averaged over the duration of the test, and as averaged between the two filters tested. The third column provides the average HPC count per milliliter (“ml”) of water for the filter effluent as averaged over the duration of the test, and as averaged between the two filters tested. As shown in the chart, the inclusion of copper particles in the carbon filter, and the combination of silver treated activated carbon and copper particles, may provide a reduction in the HPC count in the filter effluent when compared with a filter that does not contain copper or the combination of silver treated activated carbon and copper particles.

HPC Test Results

| Filter | Average Influent | Average Effluent |
|---|---|---|
| 0% Ag, 0% Cu | 8.22E04/ml | 5.02E04/ml |
| 0% Ag, 10% Cu | 8.22E04/ml | 4.97E04/ml |
| 0.1% Ag, 10% Cu | 8.22E04/ml | 4.28E04/ml |

Bacteriostatic water filter 10 of the illustrated embodiment is manufactured using conventional manufacturing techniques and apparatus. According to one embodiment, the binder (in powder form), the copper particles, and the activated carbon or the silver treated activated carbon are uniformly mixed in the proportions described above, so that the binder and copper particles are uniformly dispersed throughout the carbon. The combined carbon, copper particles, and binder are fed into a conventional cylindrical mold (not shown) having an upwardly projecting central dowel (not shown). The mold and its contents are then heated to from about 175 to about 205 degrees centigrade. After heating, the combined carbon, copper, and binder are subjected to from about 30 to about 120 pounds per square inch pressure via a conventional pressure piston (not shown), which is lowered into the mold and which includes a central clearance for the central dowel (not shown). The combined activated carbon, copper, and binder are then permitted to cool and the resulting structure is removed from the mold in the form of an integrated filter block 12.

The filter block 12 of the illustrated embodiment is then trimmed, if necessary. The nonwoven fabric scrim 22 is added to the filter block, primarily to function as a prefilter. In general, scrim 22 is and wrapped around the filter block 12. Scrim 22 may be held in place with an adhesive such as Jet-melt 3784-TC, manufactured by the 3M Corporation of St. Paul, Minn.

The optional nonwoven plastic core 14 of the illustrated embodiment is typically cut from a sheet of the desired nonwoven material. The cut sheet of material is rolled into the form of a tube and inserted into the center of the filter block 12. The core 14 can be adhesively or otherwise secured within the center of the filter block 12, but is typically held in place by frictional forces caused by its tendency to unroll and by its interaction with the end caps 16 and 18.

Top end cap 16 and neck 31 are integrally formed by injection molding of a non-permeable material, such as polypropylene. Bottom end cap 18 is also formed by injection molding of a non-permeable material, such as polypropylene. Top end cap 16 and bottom end cap 18 of the illustrated embodiment are attached to filter block 12 using hot melt adhesive. It would be obvious to one skilled in the art that other adhesives would work equivalently with the present invention.

The above description is that of a preferred embodiment of the invention. Various alterations and changes can be made without departing from the spirit and broader aspects of the invention as defined in the appended claims, which are to be interpreted in accordance with the principles of patent law including the doctrine of equivalents.

1. A fluid filter comprising:
silver treated activated carbon; and
a binder.

2. The fluid filter of claim 1, wherein the silver treated activated carbon is comprised of 0.05% to 0.15% silver by weight, based on the combined weight of the silver and the carbon.

3. The fluid filter of claim 1, wherein the silver treated activated carbon is comprised of 0.75% to 0.125% silver by weight, based on the combined weight of the silver and the activated carbon.

4. The fluid filter of claim 1, wherein the filter is adapted for use in a water treatment system.

5. The filter of claim 1, wherein the binder is comprised of a low melt index polymeric material having an ultra high molecular weight.

6. A filter comprising:
activated carbon;
copper particles; and
a binder.

7. The filter of claim 6, further comprising between 2% and 20% of copper particles by weight, based on the combined weight of the copper particles and the activated carbon.

8. The filter of claim 6, further comprising between 8% and 12% copper particles by weight, based on the combined weight of the copper particles and the activated carbon.

9. The filter of claim 6, wherein the copper particles are comprised of granular copper particles with a mesh size of 60 to 200.

10. The filter of claim 6, wherein the binder is comprised of a low melt index polymeric material having am ultra high molecular weight.

11. The filter of claim 6, wherein the activated carbon is comprised of a silver treated activated carbon.

12. The filter of claim 10, wherein the silver treated activated carbon is comprised of 0.05% to 0.15% silver by weight, based on the combined weight of the silver and the activated carbon.

13. A filter or use in a water treatment system comprising:
activated carbon treated with between 0.05% to 0.15% silver by weight, based on the combined weight of the silver and the activated carbon;
between 8% and 12% copper particles by weight, based on the combined weight of the copper particles and the silver treated activated carbon; and
a binder.

14. The filter of claim 13, wherein the copper particles are comprised of granular copper particles with a mesh size of 60 to 200.

15. The filter of claim 13, wherein the binder is comprised of a low melt index polymeric material having an ultra high molecular weight.

16. A method for making a water filter comprising the steps of:
mixing activated carbon, a binder, and copper particles; and
placing the above mixture in a mold;
heating the mixture of activated carbon, binder, and copper particles to between 175 and 205 degrees centigrade; and
subjecting the mixture of activated carbon, binder, and copper particles to about 120 pounds per square inch of pressure.

17. The method of claim 16, wherein the activated carbon is treated with between 0.05% to 0.15% silver by weight, based on the combined weight of the silver and the activated carbon.

18. The method of claim 16, wherein the copper particles further comprise between 8% and 12% copper particles by weight, based on the combined weight of the copper particles and the silver treated activated carbon.

19. The method of claim 18, the copper particles are comprised of granular copper particles with a mesh size of 60 to 200.

20. The method of claim 16, wherein the binder comprises a low melt index polymeric material having an ultra high molecular weight.
